(19) United States
(12) Patent Application Publication
(10) Pub. No.: US 2005/0215146 A1
(43) Pub. Date: Sep. 29, 2005

(54) Wiping products containing deliquescent materials

(75) Inventor: Thomas Gerard Shannon, Neenah, WI (US)

Correspondence Address: KIMBERLY-CLARK WORLDWIDE, INC., 401 NORTH LAKE STREET, NEENAH, WI, 54956, US

(73) Assignee: Kimberly-Clark Worldwide, Inc.

(21) Appl. No.: 10/808,744

(22) Filed: Mar. 24, 2004

(51) Int. Cl. B32B 5/02; B32B 3/00; B32B 9/00

(52) U.S. Cl. 442/59; 442/118; 442/414

(57) ABSTRACT

Wiping products, such as wet wipes, tissues and towels, can be improved by incorporating a sufficient amount of a deliquescent material into the product. The deliquescent material is capable of maintaining a very high equilibrium amount of water in the product which can be advantageous in preventing wet wiping products from drying out and improving the hand feel of dry wiping products.

### BACKGROUND OF THE INVENTION

Wet wipes and moist toilet paper suffer from dry-out when exposed to air for extended periods of time. This is particularly noticeable with moist toilet paper, for example, because the leading edge of the sheet that remains outside the dispenser is prone to drying out between uses, which leaves a negative consumer impression. While considerable effort is given to designing dispensers that eliminate or at least minimize the exposure of the leading edge of the sheet to ambient conditions, some exposure is inevitable for some products like moist toilet paper because complete enclosure of the product is undesirable from the standpoint of the user.

With regard to dry wiping products, such as facial tissue, dry toilet paper, table napkins, paper towels and the like, moisture in the sheet is known to impart a softness benefit by plasticizing the fibers. While it is known to add humectants to tissue products to improve the hand feel, humectants do not absorb appreciable quantities of water relative to their weight. Hence, very large amounts of the humectant material are required to absorb moisture in amounts sufficient to be effective. In addition, humectant materials do not form solutions with the water but rather exist as water/humectant complexes. Hence the water is bound to the humectant material and does not impart the same effect as free water in the sheet. Further, if the humectant material is a solid particulate, it will remain as a solid particulate in the sheet and can impart a gritty feel to the sheet.

Therefore, there is a need for an economically feasible dry wiping product having a high equilibrium moisture content so as to exhibit improved softness and pliability without increasing the grittiness of the product. Furthermore, with regard to moist wiping products, there is a need for a sheet that has a sufficiently high equilibrium moisture content such that the sheet maintains a moist feel when exposed to ambient conditions for an extended period of time.

### SUMMARY OF THE INVENTION

It has now been discovered that deliquescent materials, and in particular deliquescent inorganic salts, can be incorporated into wiping product sheets at a sufficiently high concentration so as to impart a noticeable wet feel to the product. In addition, it has been discovered that such products show no tendency to dry out when exposed to ambient humidity for extended periods of time. Furthermore, it has been found that the deliquescent salts dissolve completely within the absorbed moisture so as not to impart any grittiness to the sheet that would negatively affect the softness perception of the product.

Hence, in one aspect the invention resides in product comprising a non-woven fibrous sheet containing a deliquescent material and having an equilibrium moisture content of 10 percent or greater. As used herein, a “deliquescent material” is any solid material that can absorb a sufficient amount of moisture from the air to form a solution or any liquid material that can absorb greater than 50% by weight of water from the air to form a homogeneous aqueous solution. While any deliquescent material can be used for purposes of this invention, suitable deliquescent materials include certain inorganic salts such as aluminates, calcium chloride, lithium chloride, sodium acetate, potassium acetate and ammonium acetate and certain organic salts such as trimethylamine n-oxide.

The amount of deliquescent material in the sheets of the products of this invention can be any amount that provides the desired equilibrium moisture content. More specifically, the amount can be from about 2 to about 150 percent by weight of dry fiber or greater, more specifically from about 2 to about 125 dry weight percent, more specifically from about 3 to about 125 dry weight percent, more specifically from about 5 to about 100 dry weight percent, more specifically from about 5 to about 75 dry weight percent, more specifically from about 5 to about 50 dry weight percent and still more specifically from about 10 to about 50 dry weight percent. The specific add-on amount of the deliquescent material is not overly critical so long as the desired equilibrium moisture content is achieved and will depend upon the desired equilibrium moisture content in the sheet and the specific deliquescent material selected.

The non-woven fibrous sheet can be any low density non-woven sheet useful as a wiping product and having a dry sheet bulk of 2 cubic centimeters or greater per gram, more specifically about 3 cubic centimeters or greater per gram, more specifically about 5 cubic centimeters or greater per gram, more specifically about 10 cubic centimeters or greater per gram, more specifically from about 5 to about 25 cubic centimeters per gram, and still more specifically from about 10 to about 20 cubic centimeters per gram. Excluded are relatively high density sheets commonly used as writing papers and the like. Particularly suitable non-woven fibrous sheets include cellulosic or paper sheets useful as facial tissues, bath tissues, paper towels, table napkins, wipes and the like. Other suitable non-woven fibrous sheets include those consisting essentially of synthetic fibers or comprising a blend of synthetic and natural fibers such as are commonly used for baby wipes and other wet wipe products. Suitable natural hydrophilic fibers include those prepared from polylactic acid.

As used herein, the “dry sheet bulk” is calculated as the quotient of the “dry sheet caliper” (hereinafter defined) of a sheet, expressed in microns, divided by the dry basis weight, expressed in grams per square meter. The resulting dry sheet bulk is expressed in cubic centimeters per gram. More specifically, the dry sheet caliper is the representative thickness of a single sheet measured in accordance with TAPPI test methods T402 “Standard Conditioning and Testing Atmosphere For Paper, Board, Pulp Handsheets and Related Products” and T411 om-89 “Thickness (caliper) of Paper, Paperboard, and Combined Board” with Note 3 for stacked sheets. The micrometer used for carrying out T411 om-89 is an Emveco 200-A Tissue Caliper Tester available from Emveco, Inc., Newberg, Oreg. The micrometer has a load of 2 kilo-Pascals, a pressure foot area of 2500 square millimeters, a pressure foot diameter of 56.42 millimeters, a dwell time of 3 seconds and a lowering rate of 0.8 millimeters per second.

As used herein, the “equilibrium moisture content” represents the moisture content of the fibrous sheet at 50% relative humidity and 25° C. (standard TAPPI conditions). At equilibrium, the amount of moisture within the sheet will not change with time at the same humidity condition. The equilibrium moisture content is expressed as a weight percent of the dry sheet including the deliquescent material and any additional non-volatile components. More specifically, for dry wiping products, the dry sample sheets should be conditioned at least 4 hours at the TAPPI standard conditions prior to determining the equilibrium moisture content of the sheet. For wet wiping products, the wet sample sheets should first be dried at 100° C. for a minimum of 1 hour. The dried sample should then be conditioned at least 4 hours at TAPPI standard conditions prior to determining the equilibrium moisture content of the sheet. The equilibrium moisture content in the sheet can be controlled by the absorbent capacity of the sheet, the amount of water on a percent basis that the deliquescent material absorbs and the amount of deliquescent material in the sheet.

For wet wiping products, which require a relatively high equilibrium moisture content to avoid the appearance of being dried out, the equilibrium moisture content is suitably about 30 percent by weight of the dry fiber or greater, more specifically about 60 dry weight percent or greater, more specifically about 100 dry weight percent or greater, still more specifically from about 30 to about 120 dry weight percent and still more specifically from about 50 to about 100 dry weight percent. The deliquescent material can be incorporated into the product via any suitable means known in the art, such as by incorporating it as a component of the wet wipe wetting fluid.

For dry wiping products, the equilibrium moisture content can be lower than that desired for wet wiping products and can be from 10 to about 50 dry weight percent, more specifically from about 15 to about 50 dry weight percent and still more specifically from about 20 to about 50 dry weight percent. By comparison, cellulose sheets such as conventional tissues and towels typically have an equilibrium moisture content of about 5 percent. An elevated equilibrium moisture content in a dry wiping product can give the feel of a slightly moist sheet, which can be advantageous to the user. However, the equilibrium moisture content should not be so high that it conveys the feeling of a wet product. The deliquescent material can be incorporated into the dry wiping product by any suitable means, such as spraying or, if the sheet is made by a wet-laying process, incorporating the deliquescent material into the water used to suspend the fibers prior to sheet formation. Additionally, the deliquescent material can be added to the sheet as a neat liquid or a solid. The deliquescent material will then absorb moisture from the air and distribute throughout the sheet.

In one particular dry wiping product embodiment in which a cellulose tissue sheet is being produced, the deliquescent material (calcium chloride) is incorporated into the tissue sheet by first forming a tissue web comprising fibers and a calcium carbonate filler. The resulting tissue web is then sprayed with hydrochloric acid, which coverts the calcium carbonate to calcium chloride, water and carbon dioxide. Any residual hydrochloric acid is thereafter removed by drying of the sheet or any other method known in the art so as to leave a tissue sheet comprising calcium chloride and water and having a high equilibrium moisture content. In a specific embodiment, the calcium carbonate can be incorporated into the web by way of fibers containing calcium carbonate precipitated within the lumen or in the cell walls as disclosed by U.S. Pat. No. 4,510,020 to Green, et al. issued Apr. 9, 1985; U.S. Pat. No. 5,223,090 to Klungness et al. issued Jun. 29, 1993; U.S. Pat. No. 5,090,539 to Allan et al. issued Mar. 17, 1992 and U.S. Pat. No. 5,275,699 to Allan et al. issued Jan. 4, 1994.

Additional chemical additives, such as permanent wet strength agents, may be applied to the sheets provided their use is not antagonistic to the desired results. It is necessary to avoid a reaction that would cause precipitation of one or more components of the deliquescent material that would render the material no longer being deliquescent. For example, with calcium chloride, the interaction with sodium carbonate would cause precipitation of calcium carbonate with formation of the non-deliquescent compound sodium chloride. Hence, the resulting sheet would no longer be capable of a high equilibrium moisture content.

In a specific embodiment where the non-woven fibrous sheet is a moist bath tissue containing a salt-sensitive polymeric binder which enables the tissue to disperse or disintegrate in water, the deliquescent material serves a dual purpose of maintaining a high equilibrium moisture content in the tissue and providing high wet strength to the web by keeping the salt-sensitive binder from solubilizing. Suitable binder systems are disclosed in co-pending commonly-assigned U.S. patent application Ser. No. 10/251,610 to Branham et al. filed Sep. 20, 2002 and Ser. No. 10/251,643 to Branham et al. filed Sep. 20, 2002, both herein incorporated by reference. In a particular embodiment, the deliquescent material is selected such that the dispersibility of the sheet is not compromised by the presence of the deliquescent salt.

In the interests of brevity and conciseness, any ranges of values set forth in this specification contemplate all values within the range and are to be construed as written description support for claims reciting any sub-ranges having endpoints which are whole number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5. In addition, any of the foregoing aspects of this invention can be further defined by any combination of one or more of the specified values and ranges recited for any properties described herein.

### EXAMPLES

For the applicable examples below, the equilibrium moisture contents were determined for tissue samples as follows: Treated samples were placed in a 100° C. oven and air-dried for 1 hour. Sample sizes of 1-2 grams were selected, although larger or smaller sizes can be used depending upon the degree of accuracy desired. A dry 400 cc wide mouth jar with a screw cap was weighed and the weight (W₂) recorded to the nearest 0.001 gram. After drying, the tissue sample was placed immediately into the weighed 400 cc wide mouth jar and capped. Samples were allowed to cool to ambient temperature and the weight of the dry tissue sample and bottle (W₁) determined to the nearest 0.001 gram. The bone dry weight of the tissue sample, (W_{d}), was then calculated from the equation (W₁-W₂). The jars with sample were then uncapped and placed in TAPPI conditions to equilibrate for 16 hours. After equilibration time was complete, the jars were capped and the weight of the conditioned tissue, jar and lid (W₃) recorded. In cases where air circulation into the container is an issue, it is preferred to remove the dried samples from the sample jar and allow the samples to equilibrate on a raised rack instead of within the container. After conditioning the sample is then returned to the jar, capped and weighed. The equilibrium moisture content (Wₑ) is then calculated from the equation (W₃-W₁). The percent equilibrium moisture was then calculated from the equation [(Wₑ/W_{d})*100].

### Example 1

### Invention

15 grams of lithium chloride was dissolved in 100 cc of distilled water. A dry 2-ply mainline facial tissue weighing 1.7 grams was topically sprayed with 5 grams of the lithium chloride solution (0.75 grams lithium chloride) and placed in a 105° C. oven for 15 minutes to dry. When removed from the oven the sheet was quite stiff. Upon standing at room temperature the sheet warmed noticeably, became less stiff and eventually became noticeably wet. The sheet remained wet after sitting out for more than one week.

### Example 2

### Invention

0.5 grams of lithium chloride was placed in a plastic weighing boat. After 24 hours the weighing boat was found to contain a solution of lithium chloride that weighed 1.54 grams. This solution was absorbed into a one ply UCTAD bath tissue weighing 0.47 grams. The sheet comprising approximately 100% by weight lithium chloride and 200% by weight water retained its noticeably moist feel after standing for more than 2 weeks at ambient temperature and humidity.

### Example 3

### Invention

0.5 grams of CaCl₂ was placed in a weighing boat in the laboratory at approximately 23° C. and 50% RH. After 24 hours the CaCl₂ had absorbed 0.71 grams of water. The CaCl₂ solution was absorbed onto a wet rolled bath tissue product weighing 2.06 grams. After 3 hours the treated sheet maintained a moist feel while the untreated sheet had dried out and become noticeably stiff.

### Example 4

### Control—Humectant Treated Facial Tissue

A two-ply creped layered facial tissue having a basis weight of about 25 g/m2 was treated with a 10% polyethylene glycol solution. The polyethylene glycol had a number average molecular weight of 300 g/mole. The polyethylene glycol was applied to the dry sheet as a spray, the dry sheet having a consistency of 95%. The polyethylene glycol solution was applied to the sheet at a level of 145% by weight of dry fiber and then dried immediately after application. The total add-on of polyethylene glycol was 14.5% by weight of dry fibers. The equilibrium moisture content of the sample was determined to be 7.6%.

### Example 5

### Invention—Facial Tissue

A sample of the untreated two-ply creped layered facial tissue basesheet of Example 4 was treated with a 10% aqueous solution of lithium chloride. The lithium chloride solution was applied at a rate of 165% by weight of dry fiber to give a sheet having a lithium chloride addition level of 16.5% by weight of dry fiber. The equilibrium moisture content of the sheet was determined to be 37.8%. The sheet had a very nice soft feel with very low stiffness.

### Example 6

### Invention—Paper Towel

An uncreped through-air-dried single-ply towel basesheet having a bone dry basis weight of about 45 g/m² was treated with a 15% solution of calcium chloride. The solution was added at a level of 75% by weight of dry fiber to give a sheet having a calcium chloride content of 50% by weight of dry fiber. The sheet was found to have an equilibrium moisture content of 48.7%.

### Example 7

### Invention—Wet Wipe

A dry air-laid basesheet having a basis weight of 68 grams per square meter consisting of approximately 86% by weight southern softwood cellulosic debonded fluff pulp and 14% of an ethylene-vinyl acetate (EVA) self-crosslinking binder was treated with a 15% aqueous calcium chloride solution so that the amount of calcium chloride solution to basesheet was about 700%. The calcium chloride content of the sheet was 108% by weight of dry fiber and binder. The equilibrium moisture content of the sheet was found to be 61.6%. The equilibrated sheet felt moist to the touch and gave the impression of a moist wipe.

### Example 8

### Control—Wet Wipe

The basesheet of Example 7 was treated with a 5% aqueous saline wetting solution at a rate of approximately 200% by weight of dry fiber. The equilibrium moisture content of the sheet was found to be 2.8%.

### Example 9

### Invention—Moist Perineal Wipe

An air-laid basesheet having a basis weight of 65 grams per square centimeter containing approximately 80% debonded softwood fluff pulp and 20% of an EVA self crosslinking binder was treated with a 20% by weight lithium chloride wetting solution so as to give a lithium chloride concentration of approximately 90% by weight lithium chloride per weight of binder+fiber. The equilibrium moisture content was determined to be 98.4% by weight of dry fiber+binder+deliquescent material. The equilibrated sheet was noticeably moist and wetted the hand.

### Example 10

### Control—Moist Perineal Wipe

The basesheet of Example 9 was treated with a 5% aqueous saline wetting solution at a rate of approximately 300% by weight of dry fiber plus binder. The equilibrium moisture content of the sheet was found to be 3.5%.

The results of Examples 4-10 are summarized in Table 1 below:

TABLE 1

| | | Equilibrium |
|---|---|---|
| | | moisture |
| Example | Description | content (%) |
| 4 | Control - polyhydroxy humectant in dry tissue | 7.6% |
| 5 | Invention - 2-ply dry wet pressed creped facial | 37.8% |
| | tissue | |
| 6 | Invention - 1-ply uncreped through air dried | 48.7% |
| | towel | |
| 7 | Invention - wet wiping product | 61.6% |
| 8 | Control - wet wiping product | 2.8% |
| 9 | Invention - wet bath tissue product | 98.4% |
| 10 | Control - wet dispersible bath tissue product | 3.5% |

It will be appreciated that the foregoing description and examples, given for purposes of illustration, are not to be construed as limiting the scope of this invention, which is defined by the following claims and all equivalents thereto.

1. A wiping product comprising a non-woven fibrous sheet having a dry sheet bulk of 2 cubic centimeters or greater per gram, said sheet containing a deliquescent material and having an equilibrium moisture content of 10 dry weight percent or greater.

2. The product of claim 1 wherein the non-woven fibrous sheet comprises cellulose papermaking fibers.

3. The product of claim 1 wherein the non-woven fibrous sheet comprises synthetic fibers.

4. The product of claim 1 wherein the amount of the deliquescent material in the sheet is from about 2 to about 150 weight percent based on dry fiber.

5. The product of claim 1 wherein the amount of the deliquescent material in the sheet is from about 2 to about 125 weight percent based on dry fiber.

6. The product of claim 1 wherein the amount of the deliquescent material in the sheet is from about 3 to about 125 weight percent based on dry fiber.

7. The product of claim 1 wherein the amount of the deliquescent material in the sheet is from about 5 to about 100 weight percent based on dry fiber.

8. The product of claim 1 wherein the amount of the deliquescent material in the sheet is from about 5 to about 75 weight percent based on dry fiber.

9. The product of claim 1 wherein the amount of the deliquescent material in the sheet is from about 5 to about 50 weight percent based on dry fiber.

10. The product of claim 1 wherein the amount of the deliquescent material in the sheet is from about 10 to about 50 weight percent based on dry fiber.

11. The product of claim 1 wherein the equilibrium moisture content of the sheet is about 30 weight percent or greater based on dry fiber.

12. The product of claim 1 wherein the equilibrium moisture content of the sheet is about 60 weight percent or greater based on dry fiber.

13. The product of claim 1 wherein the equilibrium moisture content of the sheet is about 100 weight percent or greater based on dry fiber.

14. The product of claim 1 wherein the equilibrium moisture content of the sheet is from about 30 to about 120 weight percent based on dry fiber.

15. The product of claim 1 wherein the equilibrium moisture content of the sheet is from about 50 to about 100 weight percent based on dry fiber.

16. The product of claim 1 wherein the equilibrium moisture content of the sheet is from about 10 to about 50 weight percent based on dry fiber.

17. The product of claim 1 wherein the equilibrium moisture content of the sheet is from about 15 to about 50 weight percent based on dry fiber.

18. The product of claim 1 wherein the equilibrium moisture content of the sheet is from about 20 to about 50 weight percent based on dry fiber.

19. The product of claim 1 wherein the deliquescent material is a salt selected from the group consisting of aluminates, calcium chloride, lithium chloride, sodium acetate, potassium acetate, ammonium acetate and trimethylamine n-oxide.

20. The product of claim 1 wherein the deliquescent material is lithium chloride.

21. The product of claim 1 wherein the deliquescent material is calcium chloride.

22. The product of claim 1 wherein said product is a facial tissue.

23. The product of claim 1 wherein said product is a bath tissue.

24. The product of claim 1 wherein said product is a paper towel.

25. The product of claim 1 wherein said product is a wet wipe.

26. The product of claim 1 wherein said product is a wet wipe containing a water-dispersible binder.

27. The product of claim 1 wherein said product is water-dispersible.
